(19) United States
(12) Patent Application Publication
(10) Pub. No.: US 2009/0322145 A1
(43) Pub. Date: Dec. 31, 2009

(54) SPOKED BICYCLE WHEEL ASSEMBLY WITH NON-PERFORATED RIM

(76) Inventor: Damon Rinard, Monona, WI (US)

Correspondence Address: BOYLE FREDRICKSON S.C., 840 North Plankinton Avenue, MILWAUKEE, WI, 53203, US

(21) Appl. No.: 12/145,851

(22) Filed: Jun. 25, 2008

(51) Int. Cl. B60B 21/06; B21D 53/26

(52) U.S. Cl. 301/58; 29/894.33

(57) ABSTRACT

A wheel assembly for bicycles that includes a rim having a number of nipple supports attached thereto. A number of nipple supports are attached to a rim and extend in a radially inward direction relative to the rim. One or more openings are formed in each nipple support. The openings are shaped to cooperate with a respective spoke nipple. A cavity is formed between each nipple support and the rim such that the spoke nipples can be engaged with the supports from a circumferential direction.

### BACKGROUND OF THE INVENTION

The present invention relates generally to bicycle wheels and, more particularly, to a bicycle wheel having a number of nipple supports than extend radially inward from the rim.

Several aspects of bicycle operation rely on the construction of the bicycle wheel rim. The bicycle wheel rim is constructed to support a tire, to be operatively connected to a hub, and frequently constructed to engage a braking system. Accordingly, rider operation and control of the bicycle depends heavily upon the construction and performance of the wheel rim.

With respect to braking operation, the wheel rim is frequently provided with a generally vertically orientated upstanding wall constructed to operatively engage a brake pad of a bicycle braking system. Such systems are frequently configured to pinch the walls of the rim between the oppositely facing brake pads. Unfortunately, providing a vertically orientated braking wall presents several drawbacks.

The generally vertical orientation of the rim wall to interact with the brakes pads substantially increases the mass and complexity of rim construction. That is, the rims must be constructed to withstand the shear and compression forces generated during braking operations. This is generally accomplished by increasing the thickness and thereby the mass of the rim.

Many wheel rims are constructed to include a pair of inwardly facing hooks that are formed at the radially outward facing ends of the brake sidewalls of the rim. The hooks are constructed to engage corresponding beads formed on the tire. The vertical orientation of the rim sidewalls generally aligns the rim with the tire sidewall such that the interface between the tire and the rim is generally transverse to a plane of rotation of the rim during operation. The tire bead and the rim hook interlock to maintain the engagement between the tire and the rim. During aggressive riding and/or cornering, the forces associated with the interface of the tire and the rim are not necessarily normalized to one another thereby resulting in the concentration of shearing stresses at the interface between the tire and the rim. Although such stresses are not normally problematic, it would be desirable to improve the interface between the rim and the tire to enhance the communication of shear forces therebetween. Understandably, any such alteration must also consider the additional forces communicated to the rim.

Another consideration of rim construction is the interaction of the rim with the respective spokes. Commonly, a number of holes are formed in the rim. Each hole cooperates with a nipple that engages a respective spoke. The nipples are frequently introduced into the holes from a position commonly enclosed by the tire. Accordingly, servicing of a respective spoke and/or nipple frequently requires that the tire be removed from the rim. Such a requirement increases the time and effort associated with servicing a spoke and/or nipple.

Positioning the nipples such that a head portion of the nipple extends generally into the cavity enclosed by the tire presents another complication with respect to tire configurations that have tubes. Generally, the surfaces exposed to the volume enclosed by the rim and the tire needs to be generally smooth to maintain the integrity of the tube. A rim with nipple perforations is not smooth. A rim strip is normally used to smooth over the nipple perforations in order to protect the integrity of the tube. Eliminating the nipple perforations in the rim eliminates the need to use a rim strip. A rim without a rim strip simplifies tire mounting and reduces the overall weight of such a wheel assembly.

Another consideration of rim construction is the possibility to use a tubeless tire. Nipple perforations, present an opportunity for air to leak from the tire. Accordingly, many tubeless wheel assemblies provide alternative methods of sealing the rim, such as the use of a specially formed sealing strip. Rim strip members, whether they protect other wheel components or perform a sealing function, complicate the wheel construction and add weight to the wheel assembly.

Accordingly, it would be desirable to have a system and method capable of providing a bicycle wheel rim that is lightweight, robust and enhances the interface of a tire therewith. Furthermore, it is further appreciated that any such rim should also be aesthetically pleasing and provide a generally continuous or uninterrupted surface to reduce undesired interaction with a tire or tube.

### BRIEF DESCRIPTION OF THE INVENTION

The present invention provides a system and method of forming a bicycle wheel that overcomes one or more of the aforementioned drawbacks. A wheel assembly according to one aspect of the invention includes a number of nipple supports that are attached to a rim. Each nipple support is attached to the rim and extends in a radially inward direction relative to the rim. One or more openings are formed in each nipple support and shaped to cooperate with a respective spoke nipple. A cavity is formed between each nipple support and the rim such that the spoke nipples can be assembled into the supports from a circumferential direction. Such a construction provides a wheel assembly having a rim that is lightweight and generally non-perforated.

Another aspect of the invention usable with one or more features of the above aspect includes a bicycle wheel having a hub that is constructed to cooperate with an axle and a rim that extends circumferentially about the hub. A number of spokes extend from the hub and engage a nipple at a rim facing end of each spoke. A number of nipple mounts are secured to the rim for engaging the nipples. Each nipple mount includes a pair of generally oppositely facing side sections and a mid-section. The side sections are secured to the generally opposite lateral sides of the rim and the mid-section is disposed between the side sections so as to be offset from the rim such that a gap is formed between the mid-section of each nipple mount and the rim. At least one hole is formed in the mid-section of the each nipple mount and cooperates with a respective nipple such that each spoke is tensioned between a respective nipple mount and the hub.

Another aspect of the invention usable with one or more of the features discussed above includes a method of forming a bicycle wheel that includes providing a hub and a number of spokes. A rim having a generally round circumferential shape and a generally non-perforated body is positioned about the hub. A number of spoke mount cradles are provided. Each spoke mount cradle includes at least one nipple hole. The number of spoke mount cradles are secured to the rim in a circumferentially spaced manner such that opposite circumferential ends of each spoke mount cradle are accessible and each nipple hole is offset radially inward from the non-perforated body of the rim. A number of nipples are provided such that each nipple cooperates with a respective nipple hole to tension a respective spoke between the hub and a respective spoke mount cradle.

A further feature of the invention usable with one or more of the aspects above is to form at least two openings in each mount cradle or nipple support to cooperate with at least two nipples. Such a configuration provides a wheel assembly having at least twice as many spokes as spoke mounts.

Another aspect of the invention to be considered in addition to one or more of the above features and aspects is to provide the nipple supports with openings that are laterally offset from a plane of rotation of the rim to achieve a desired lateral performance of the wheel assembly.

Preferably, the oppositely facing side walls of each nipple support are bonded to the generally oppositely facing and upwardly extending legs of the cross-section of the rim. It is further envisioned that any of the supports discussed above be formed from a carbon fiber based material, a composite based material, or a metal material.

These and various other features and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is an elevation view of a bicycle equipped with a front wheel assembly having a number of nipple supports and constructed according to the present invention;

FIG. 2 is a perspective view of one of the nipple mounts of the wheel assembly taken along line 2-2 shown in FIG. 1;

FIG. 3 is a cross-sectional view of the nipple mount secured to the rim and taken along line 3-3 shown in FIG. 2; and

FIG. 4 is a plan view of a portion of the wheel assembly shown in FIG. 1 viewed from a center of rotation in a radially outward direction.

### DETAILED DESCRIPTION OF THE PREFERRED EMBODIMENT

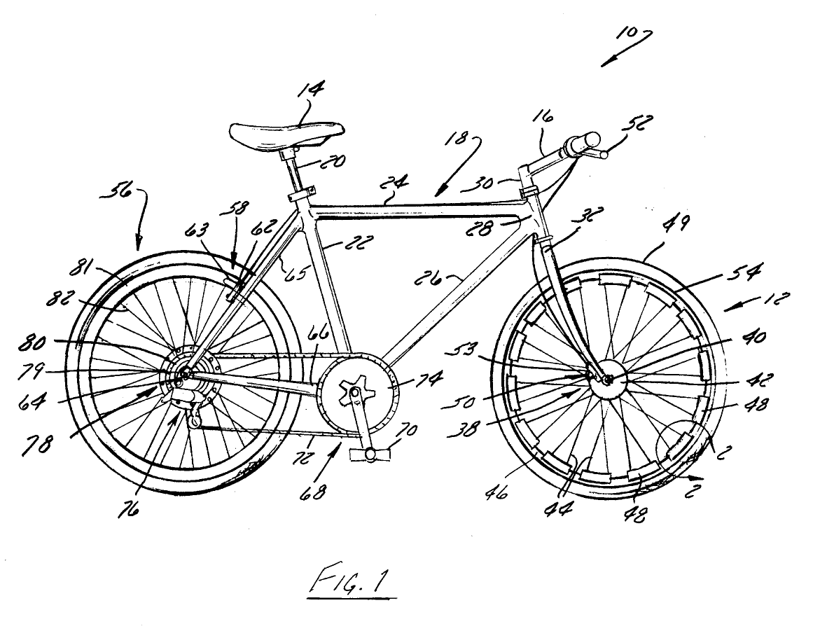

FIG. 1 shows a bicycle 10 equipped with a front wheel assembly 12 according to the present invention. Bicycle 10 includes a seat 14 and handlebars 16 that are attached to a frame 18. A seat post 20 is connected to seat 14 and slidably engages a seat tube 22 of frame 18. A top tube 24 and a down tube 26 extend forwardly from seat tube 22 to a head tube 28 of frame 18. Handlebars 16 are connected to a stem 30 that passes through head tube 28 and engages a fork crown 32. A pair of forks 34 extend from generally opposite ends of fork crown 32 and are constructed to support front wheel assembly 12 at an end thereof or fork tips 38. Fork tips 38 engage generally opposite sides of an axle 40 that is constructed to engage a hub 42 of front wheel assembly 12. A number of spokes 44 extend between hub 42 and a rim 46 of front wheel assembly 12. A number of spoke mounts 48 are affixed to rim 46 and cooperate with one or more of spokes 44 for tensioning spokes 44 in wheel assembly 12. A tire 49 is positioned about rim 46 such that rotation of tire 49, relative to forks 34, rotates rim 46 and hub 42.

Bicycle 10 includes a front brake assembly 50. Front brake assembly 50 includes an actuator 52 that is attached to handlebars 16 and a caliper having a pair of brake pads 53 that are positioned on generally opposite sides of a rotor. Brake pads 53 are constructed to engage the rotor thereby providing a stopping or slowing force to front wheel assembly 12. Alternatively, front wheel assembly 12 could be provided with a brake caliper positioned to engage a brake wall 54 positioned radially outward relative to nipple supports 48.

Bicycle 10 includes a rear wheel assembly 56 that includes a rear wheel brake assembly 58. Brake assembly 58, unlike front disc brake assembly 50, includes a caliper 62 and a set of brake pads 63 that are positioned on generally opposite lateral sides of wheel assembly 56. Understandably, either or both of front and rear wheel brake assemblies 50, 58 could be provided as rotor or disc type brakes such as front brake assembly 50 wherein the brake assembly is mounted nearer either of front axle 40 or a rear axle 64 or as a system configured to configured to cooperate with the wheel rim, such as brake system 58.

A seat stay 65 and a chain stay 66 offset rear axle 64 from a crankset 68. Crankset 68 includes a pedal 70 that is operationally connected to a chain 72 via a chain ring or sprocket 74. Rotation of chain 72 communicates a drive force to a rear section 76 of bicycle 10. A gear cluster 78 is positioned about axle 64 proximate rear section 76. Gear cluster 78 is generally concentrically orientated with respect to rear axle 64 and includes a number of variable diameter gears 79 that each cooperate with chain 72.

Gear cluster 78 is operationally connected to a hub 80 of rear wheel assembly 56. A number of spokes 82 extend between hub 80 and a rim 81 of rear wheel assembly 56. It is appreciated that although rear wheel assembly 56 is shown as having a number of spokes that directly engage rim 81, rear wheel assembly 56 could also be constructed to include one or more nipple mounts that would extend inward relative to rim 81 and cooperate with one or more of spokes 82 in accordance with the construction of front wheel assembly 12. That is, bicycle 10 could be provided with one or more wheels equipped with nipple supports 48. In addition to providing a front or rear wheel, it is further appreciated that wheel assembly 12 is applicable to bicycles provided as a rugged terrain, mountain, or off road type bicycles and bicycles intended for operation on generally smooth or paved surfaces, i.e. road bikes.

FIG. 2 shows a perspective view of an area of front wheel assembly 12 proximate one nipple support 48 taken along line 2-2 shown in FIG. 1. As shown in FIG. 2, rim 46 is constructed in a generally continuous manner from a relatively unitary body 84. That is, rim 46 is generally non-perforated although an opening associated with a tire valve stem may be formed therein. Other than the valve stem opening, it is envisioned that body 84 of rim 46 be generally continuous and uniform about the circumference of wheel assembly 12. Rim 46 includes a pair of generally opposite side walls 90, 92 that extend from a center portion 94 to two laterally spaced ends 96, 98, respectively. A web 100 extends between sidewalls 90, 92 proximate ends 96, 98. A bead seat 102, 104 is formed near each end 96, 98 of each sidewall 90, 92. Tire 108 includes a pair of beads 110, 112 that are received in a respective bead seat 102, 104. Beads 110, 112 cooperate with bead seats 102, 104 such that tire 108 and a portion of web 100 sealingly enclose a cavity 111. It is appreciated that cavity 111 could also be configured to receive a tire tube or the like such that the interaction between seats 102, 104 and beads 110, 112 would be less important to tire performance.

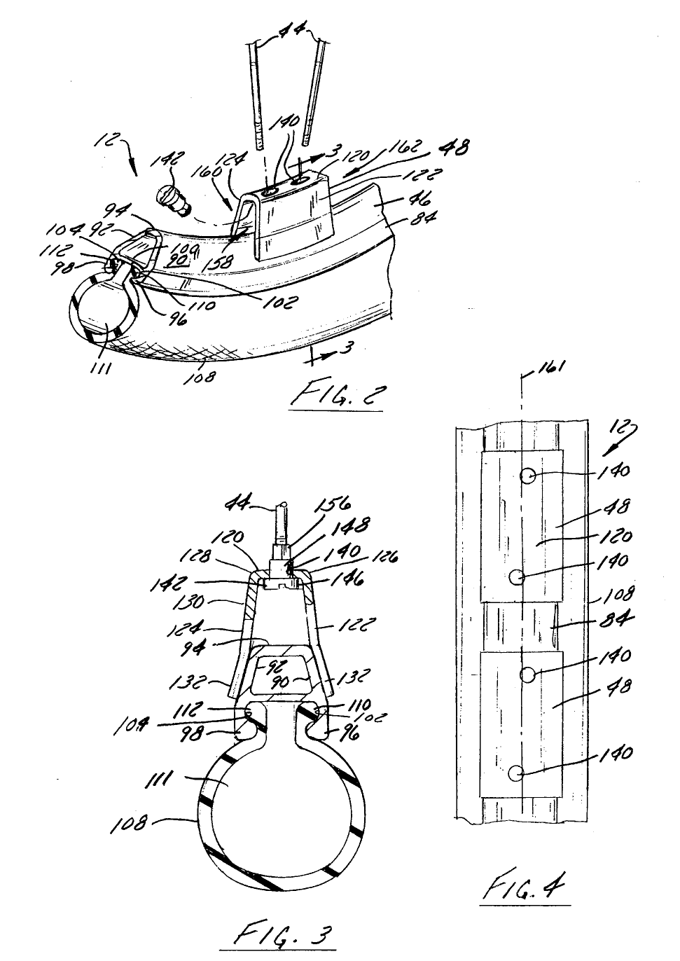

As shown in FIGS. 2 and 3, each nipple support 48 includes a center portion 120 and a pair of side portions 122, 124. Each side portion 122, 124 extends from a generally opposite end 126, 128 of center portion 120. As best shown in FIG. 3, each side portion 122, 124 includes a first or offset section 130 and a second or binding section 132. Each binding section 132 is contoured to generally match a contour of a portion of sidewall 90, 92 of rim 46. Preferably, each binding section 132 is permanently affixed to one of sidewalls 90, 92. Support 48 can be constructed of any of a number of materials such as metal, carbon fiber, a composite material, and/or combinations thereof. Support 48 is constructed to be bonded to walls 90, 92 of rim 46 such as via gluing, bonding with an epoxy, welding, and/or being soldered thereto. Understandably, the bonding modality depends in part upon the material of nipple support 48 and rim 46. Preferably, each support 48 is non-removably secured to rim 46.

Referring back to FIG. 2, each nipple support 48 includes at least one opening 140 for securing respective spokes 44 to a respective nipple support 48. A spoke nipple 142 cooperates with each opening 140 and engages respective spokes 44. As shown in FIG. 3, each nipple 142 includes a head portion 146 and a shoulder portion 148. Shoulder portion 148 passes slidably through opening 140 whereas head portion 146 is unable to pass through opening 140. A number of lands 156 are formed near or about shoulder portion 148. Lands 156 cooperate with a tool to allow rotation of nipple 142 relative to spoke 44, allowing an operator to conveniently adjust the tension of each respective spoke 44.

As shown in FIG. 2, center portion 120 of each nipple support 48 is offset from center portion 94 of rim 46 thereby defining a cavity or passage 158 that is generally enclosed by nipple support 48 and center portion 94 of rim 46. Passage 158 includes a pair of open opposite ends 160, 162 such that each nipple 142 can pass through a respective open end 160, 162 to be engaged with an opening 140 formed in center portion 120 of nipple support 48. Although each nipple support 48 is shown as having two openings 140, nipple supports 48 having more or fewer than two openings 140 are envisioned.

FIG. 4 shows a portion of wheel assembly 12 including two nipple supports 48 as viewed in a radially outward direction from the center of the wheel assembly 12. During use, wheel assembly 12 rotates in a plane of rotation, indicated by line 161. Body 84 of rim 46 extends in a generally uninterrupted and continuous manner between adjacent nipple mounts 48. As shown, each nipple mount 48 includes two openings 140 that are laterally offset from plane of rotation 161 so as to achieve a desired lateral performance of wheel assembly 12. Understandably, openings 140 could be aligned with plane of rotation 161 if desired. Furthermore, in those embodiments wherein nipple mount 48 includes more or fewer than two openings 140, adjacent openings or openings of adjacent mounts 48 can be configured and positioned relative to plane of rotation 161 about the circumference of rim 46 to achieve a desired radial and lateral spoke spacing.

The generally non perforated construction of body 84 of rim 46 allows rim 46 to be constructed with an overall thinner wall thickness. Furthermore, nipple supports 48 distribute the lateral and torque load associated with each of the spokes 44 secured thereto over a greater area of the body 84 of rim 46. Distributing the load associated with any given spoke over a greater area of rim 46 allows the overall thickness of rim 46 to be reduced. Rim 46 has a generally uniform cross-sectional area across nearly the entirety of the circumference of rim 46 thereby simplifying the construction of rim 46 while reducing the overall weight of wheel assembly 12. Furthermore, as rim 46 of wheel assembly 12 includes no spoke perforations through body 84, wheel assembly 12 overcomes the attributes commonly associated with rim and sealing strips as discussed above. In addition to being convenient to assemble and service, such a construction provides a wheel assembly that is lightweight, robust, and can withstand the rigors of aggressive riding.

The present invention has been described in terms of the preferred embodiment, and it is recognized that equivalents, alternatives, and modifications, aside from those expressly stated, are possible and within the scope of the appending claims.

What is claimed is:

1. A wheel assembly constructed to be connected to a bicycle and rotate about an axis and in a plane of rotation, the wheel assembly comprising:
a rim having a circular shape and a generally U-shaped cross-section
a number of supports attached toward a radially inward facing side the rim, each support having oppositely facing open ends and defining a cavity between the rim and the support;
at least one opening formed in each support; and
at least one nipple constructed to pass into the cavity and cooperate with the at least one opening for securing a spoke to the rim.

2. The wheel assembly of claim 1 wherein each support includes at least two openings wherein each opening is positioned near an open end of the support.

3. The wheel assembly of claim 2 wherein the two openings are laterally offset from one another with respect to the plane of rotation of the wheel assembly.

4. The wheel assembly of claim 1 wherein the wheel assembly includes more spokes than supports.

5. The wheel assembly of claim 1 wherein each support includes a pair of oppositely facing side walls that are attached to generally oppositely facing sidewalls of the rim.

6. The wheel assembly of claim 1 wherein the support is formed of one of a carbon fiber based material, a composite based material, or a metal material.

7. The wheel assembly of claim 1 wherein the rim has a substantially continuous non-perforated body.

8. The wheel assembly of claim 1 further comprising a tube-less tire sealingly disposed about an open side of the U-shaped cross-section of the rim.

9. The wheel assembly of claim 1 wherein there is no strip member disposed between the rim and an interior surface of a tire.

10. A bicycle wheel comprising:
a hub constructed to cooperate with an axle;
a number of spokes extending from the hub;
a nipple engaged with an end of each spoke that is remote from the hub;
a rim extending circumferentially about the hub;
a number of nipple mounts, each nipple mount having a pair of generally oppositely facing side sections and a mid-section, the side sections being secured to generally opposite lateral sides of the rim and the mid-section disposed between the side sections so as to be offset from the rim;
a gap between the mid-section of each nipple mount and the rim; and
at least one hole formed in the mid-section of each nipple mount for cooperating with a respective nipple such that each spoke can be tensioned between respective nipple mounts and the hub.

11. The bicycle wheel of claim 10 wherein the mid-section of each nipple mount extends in a direction generally aligned with the axle.

12. The bicycle wheel of claim 10 wherein each nipple mount includes another hole wherein the at least one hole and another hole are formed proximate opposite ends of the nipple mount with respect to a circumferential orientation of the rim.

13. The bicycle wheel of claim 12 wherein adjacent holes are laterally offset from one another such that adjacent spokes are offset in a staggered manner with respect to a plane of rotation of the rim.

14. The bicycle wheel of claim 10 wherein each nipple mount is bonded to the rim.

15. The bicycle wheel of claim 10 wherein each nipple includes a stem portion that passes through the at least one hole and a head portion that is larger than the at least one hole.

16. The bicycle wheel of claim 15 wherein each nipple has a length that allows the nipple to be inserted into the at least one hole when positioned in the gap.

17. The bicycle wheel of claim 10 wherein the oppositely facing side sections of each nipple mount includes a first portion that extends in a direction generally aligned with an axial direction of a respective spoke and a second portion oriented to correspond to a profile of a respective lateral side of the rim.

18. A method of forming a bicycle wheel comprising:
providing a hub and a number of spokes;
providing a rim having a generally round circumferential shape and a generally non-perforated body;
providing a number of spoke mount cradles, each spoke mount cradle having at least one nipple hole;
securing the number of spoke mount cradles to the rim in a circumferentially spaced manner such that opposite ends of each spoke mount cradle are accessible and each nipple hole is offset from the non-perforated body of the rim; and
providing a number of nipples wherein each nipple cooperates with a respective nipple hole to tension a respective spoke between the hub and a respective spoke mount cradle.

19. The method of claim 18 wherein the number of spoke mount cradles are bonded to generally opposite lateral sides of the rim.

20. The method of claim 18 further comprising passing an axle through the hub and securing the axle to a bicycle.

21. The method of claim 18 wherein the step of providing the number of spoke mount cradles further comprises forming each spoke mount cradle to be cup shaped such that the at least one nipple hole is located generally in a lower portion of the cup shape.

22. The method of claim 18 further comprising forming each spoke to be shorter than a distance between the hub and the generally non-perforated body of the rim.
